(19) United States
(12) Patent Application Publication
(10) Pub. No.: US 2020/0125144 A1
(43) Pub. Date: Apr. 23, 2020

(54) FOLDABLE ELECTRONIC DEVICE FOR CONTROLLING USER INTERFACE AND OPERATING METHOD THEREOF

(71) Applicant: Samsung Electronics Co., Ltd., Suwon-si (KR)

(72) Inventors: Jinkyo CHUNG, Suwon-si (KR); Yong KWON, Suwon-si (KR); Sukjae LEE, Suwon-si (KR)

(21) Appl. No.: 16/661,140

(22) Filed: Oct. 23, 2019

(30) Foreign Application Priority Data
Oct. 23, 2018 (KR) 10-2018-0126468

(51) Int. Cl. G06F 1/16; H04M 1/02; G01B 11/26; G06F 3/14; G06F 3/041

(52) U.S. Cl. CPC G06F 1/1652; G06F 1/1641; G06F 3/0414; G01B 11/26; G06F 3/1423; H04M 1/0268

(57) ABSTRACT

A foldable electronic device for controlling a user interface and its operating method are provided. The operating method includes detecting an angle between first housing of the electronic device and a second housing of the electronic device using at least one sensor circuit, when the angle is within a first range, displaying a first user interface of a first application, the first user interface comprising a first object displayed in a first area, and when the angle is within a second range, displaying a second user interface of the running application, the second user interface comprising the first object that is displayed in a second area, wherein the first area may include a partial area that corresponds to a position of a hinge, and the second area may be different from the first area.

### CROSS-REFERENCE TO RELATED APPLICATION(S)

This application is based on and claims priority under 35 U.S.C. § 119(a) of a Korean patent application number 10-2018-0126468, filed on Oct. 23, 2018, in the Korean Intellectual Property Office, the disclosure of which is incorporated by reference herein in its entirety.

### BACKGROUND

### 1. Field

The disclosure relates to a foldable electronic device for controlling a user interface and its operating method.

### 2. Description of Related Art

With advances in a communication network such as Internet, various contents are developed. To provide such various contents, an electronic device including a flexible display or a plurality of displays is under development. Such an electronic device may be implemented in a foldable type, to provide improved usability.

The foldable electronic device may be changed in its mechanical state by a user gesture. For example, the foldable electronic device of an unfolded state may change into a folded in state or a closed state.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device may provide a fixed user interface, regardless of a change of a mechanical state. For example, the electronic device may provide a user interface configured the same as in a folded out state and a folded in state. However, the mechanical state change of the electronic device may degrade user accessibility to an area where two surface of the electronic device meet. For example, if the electronic device is folded, it may be difficult for a user to select (or touch) an object displayed in the area where the two surface of the electronic device meet.

Another aspect of the disclosure is to provide a method and an apparatus for controlling a user interface based on a mechanical state change of an electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a hinge, a first housing including a first surface which faces a first direction and a third surface which faces a second direction facing away the first direction, a second housing including a second surface which faces the first direction and a fourth surface which faces the second direction facing away the first direction, and folding with the first housing based on the hinge, a flexible display extending from the first surface to the second surface, at least one sensor circuit for detecting an angle of the first housing and the second housing, and a processor operatively coupled with the flexible display and the sensor circuit, wherein the processor may be configured to, if the angle detected through the sensor circuit corresponds to a designated first range, control the flexible display to display a first user interface corresponding to a running application, and if the angle detected through the sensor circuit corresponds to a designated second range, control the flexible display to display a second user interface corresponding to the running application, wherein the second user interface may include the same object as the first user interface, and displays at least one object displayed in a first area, in a second area in the first user interface, the first area may include a partial area corresponding to a position of the hinge in a whole area of the flexible display, and the second area may be a different area from the first area.

In accordance with another aspect of the disclosure, an operating method of an electronic device is provided. The operating method includes detecting a folding angle of the electronic device using at least one sensor circuit, if the determined angle corresponds to a designated first range, displaying a first user interface corresponding to a running application, and if the determined angle corresponds to a designated second range, displaying a second user interface corresponding to the running application, wherein the second user interface may include the same object as the first user interface, and displays at least one object displayed in a first area, in a second area in the first user interface, the first area may include a partial area corresponding to a position of a hinge in a whole area of a flexible display, and the second area may be a different area from the first area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of an unfolded electronic device according to an embodiment of the disclosure;

FIG. 2 is a block diagram of an electronic device in a network environment according to an embodiment of the disclosure;

FIG. 3 is a block diagram of a program module according to an embodiment of the disclosure;

FIGS. 4A and 4B are diagrams of a program module for detecting and processing a folding state in an electronic device according to various embodiments of the disclosure;

FIG. 5 is a flowchart for controlling a user interface based on a mechanical state change in an electronic device according to an embodiment of the disclosure;

FIGS. 6A and 6B are screen views for controlling a user interface based on a mechanical state change in an electronic device according to an embodiment of the disclosure;

FIG. 7 is a flowchart for controlling a user interface based on a grip mode in an electronic device according to an embodiment of the disclosure;

FIGS. 8A, 8B, 8C, 8D, 8E, and 8F are screen views for controlling a user interface based on a grip mode in an electronic device according to various embodiments of the disclosure;

FIG. 9 is a flowchart for controlling a user interface based on a designated condition in an electronic device according to an embodiment of the disclosure;

FIGS. 10A, and 10B, are screen views for controlling a user interface based on a designated condition in an electronic device according to various embodiments of the disclosure;

FIG. 11 is a flowchart for controlling a user interface based on a mainly used surface in an electronic device according to an embodiment of the disclosure;

FIGS. 12A and 12B are screen views for controlling a user interface based on a mainly used surface in an electronic device according to various embodiments of the disclosure;

FIG. 13 is a flowchart for controlling a user interface based on an object use frequency in an electronic device according to an embodiment of the disclosure;

FIG. 14 is a screen view for controlling a user interface based on a use frequency in an electronic device according to an embodiment of the disclosure;

FIG. 15 is a flowchart for controlling a changed user interface based on a mechanical state change in an electronic device according to an embodiment of the disclosure; and

FIGS. 16A and 16B are screen views for controlling a changed user interface based on a mechanical state change in an electronic device according to various embodiments of the disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

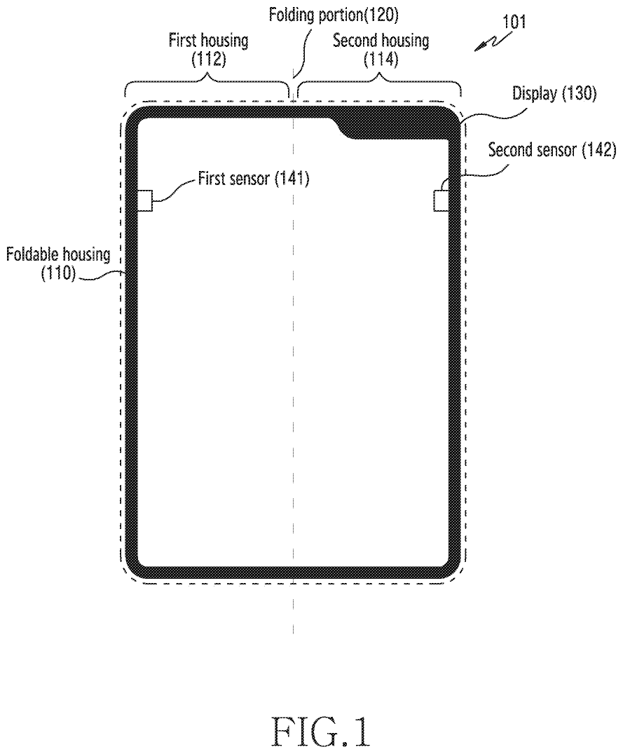

FIG. 1 is a diagram of an unfolded electronic device according to an embodiment of the disclosure.

Referring to FIG. 1, an electronic device 101 according to various embodiments may include a foldable housing 110, a folding portion 120, and a display 130. The display 130 may be a flexible or foldable display disposed in a space formed by the foldable housing 110.

According to various embodiments, the foldable housing 110 may include a first housing 112 and a second housing 114. The first housing 112 may include a first surface (or a first front surface) and a third surface (or a first rear surface) which faces away from the first surface. The second housing 114 may include a second surface (or a second front surface) and a fourth surface (or a second rear surface) which faces away from the second surface.

According to various embodiments, the first housing 112 and the second housing 114 may be disposed on both sides of the folding portion 120, and connected by the folding portion 120. For example, the folding portion 120 may be coupled with a side surface of the first housing 112 and a side surface of the second housing 114 which faces the side surface of the first housing 112, and thus pivotably or rotatably interconnect the first housing 112 and the second housing 114.

According to various embodiments, the display 130 may be disposed on the first housing 112 and the second housing 114 by traversing the folding portion 120. The display 130 may be supported by the first housing 112 and the second housing 114. In various embodiments, the display 130 may be disposed on the first surface of the first housing 112 and the second surface of the second housing 114 by traversing the folding portion 120.

The electronic device 101 according to various embodiments may be folded based on the folding portion 120. For example, the folding portion 120 may be disposed between the first housing 112 and the second housing 114 of the electronic device 101, to bend, curve, or fold the electronic device 101. According to various embodiments, the first housing 112 may be connected to the second housing 114 through the folding portion 120, and may rotate based on the folding portion 120. According to various embodiments, the second housing 114 may be connected to the first housing 112 through the folding portion 120, and may rotate based on the folding portion 120. According to various embodiments, the first housing 112 and the second housing 114 may rotate based on the folding portion 120 and be folded to face each other. In various embodiments, the first housing 112 and the second housing 114 may be substantially folded or overlapped. For example, the first housing 112 and the second housing 114 rotate and fold based on the folding portion 120, wherein the first surface of the first housing 112 and the second surface of the second housing 114 face each other or the third surface of the first housing 112 and the fourth surface of the second housing 114 face each other.

According to various embodiments, the first housing 112 and the second housing 114 of the electronic device 101 may be folded out by means of the folding portion 120. According to various embodiments, if the electronic device 101 is folded out, the first surface of the first housing 112 may be substantially flush with the second surface of the second housing 114. In various embodiments, the folded out state of the electronic device 101 may indicate that a user's field of view or angle of view heading toward the front surface of the electronic device 101 covers all of a left area corresponding to the first surface of the entire area of the display 130, a right area corresponding to the second surface of the entire area of the display 130, and a center area corresponding to the folding portion 120 of the entire area of the display 130. The center area may overlap with at least part of the left area and at least part of the right area.

According to various embodiments, the first housing 112 and the second housing 114 of the electronic device 101 may be folded in by means of the folding portion 120. According to various embodiments, if the electronic device 101 is folded in, the first surface of the first housing 112 and the second surface of the second housing 114 may make an angle within a designated range. For example, if the electronic device 101 is folded in, the angle between the first surface of the first housing 112 and the second surface of the second housing 114 may be greater than 0 degree and smaller than 180 degrees.

According to various embodiments, the electronic device 101 may close the first housing 112 and the second housing 114 by means of the folding portion 120. According to various embodiments, if the electronic device 101 is closed, the first surface of the first housing 112 and the second surface of the second housing 114 may face each other and be substantially flush with each other. According to various embodiments, the closed state may indicate that the display 130 is hidden in the user's field of view which faces the front surface of the electronic device 101.

According to various embodiments, at least one sensor may be disposed in each of the first housing 112 and the second housing 114. For example, a first sensor 141 may be disposed in the first housing 112, and a second sensor 142 may be disposed in the second housing 114. According to an embodiment, the first sensor 141 and the second sensor 142 may acquire angle information between the first housing 112 and the second housing 114. The first sensor 141 may include at least one of, for example, a gyroscope sensor, a distance sensor, or a strain sensor. The second sensor 142 may include at least one of, for example, a gyroscope sensor, a distance sensor, or a strain sensor.

According to various embodiments, the folding portion 120 may include a hinge and a hinge cover, and the hinge may be covered by the hinge cover.

According to various embodiments, the display 130 may be coupled with a touch sensor (not shown) for detecting a touch input, and thus may be configured as an integrated touchy screen. If the display 130 is the touch screen, the touch sensor may be disposed on or below the display 130.

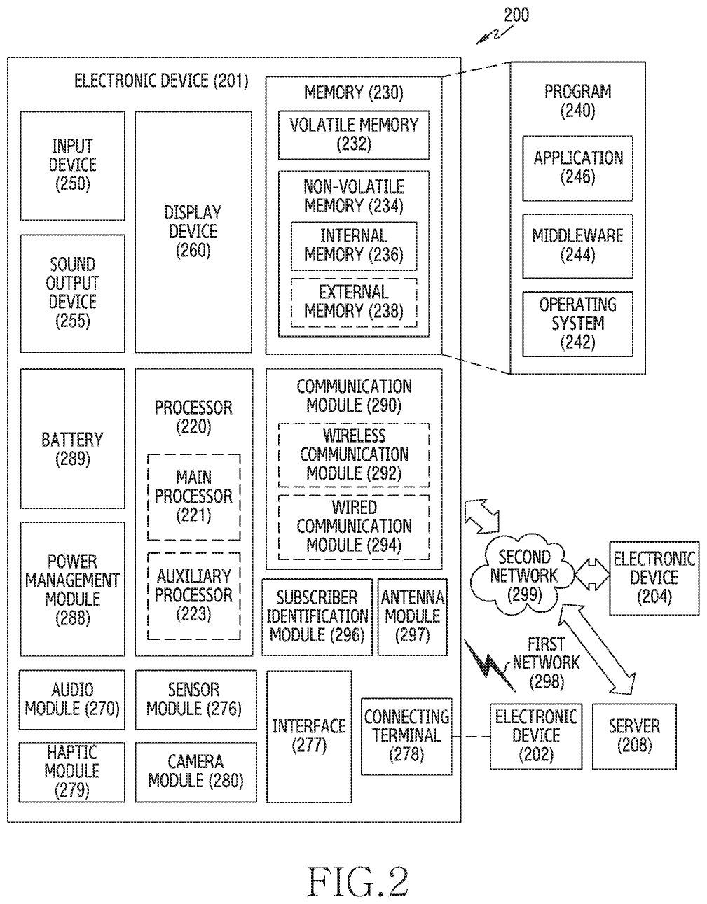

FIG. 2 is a block diagram illustrating an electronic device 201 in a network environment 200 according to an embodiment of the disclosure.

Referring to FIG. 2, the electronic device 201 in the network environment 200 may communicate with an electronic device 202 via a first network 298 (e.g., a short-range wireless communication network), or an electronic device 204 or a server 208 via a second network 299 (e.g., a long-range wireless communication network). According to an embodiment, the electronic device 201 may communicate with the electronic device 204 via the server 208. According to an embodiment, the electronic device 201 may include a processor 220, memory 230, an input device 250, a sound output device 255, a display device 260, an audio module 270, a sensor module 276, an interface 277, a haptic module 279, a camera module 280, a power management module 288, a battery 289, a communication module 290, a subscriber identification module (SIM) 296, or an antenna module 297. In some embodiments, at least one (e.g., the display device 260 or the camera module 280) of the components may be omitted from the electronic device 201, or one or more other components may be added in the electronic device 201. In some embodiments, some of the components may be implemented as single integrated circuitry. For example, the sensor module 276 (e.g., a fingerprint sensor, an iris sensor, or an illuminance sensor) may be implemented as embedded in the display device 260 (e.g., a display).

The processor 220 may execute, for example, software (e.g., a program 240) to control at least one other component (e.g., a hardware or software component) of the electronic device 201 coupled with the processor 220, and may perform various data processing or computation. According to one embodiment, as at least part of the data processing or computation, the processor 220 may load a command or data received from another component (e.g., the sensor module 276 or the communication module 290) in volatile memory 232, process the command or the data stored in the volatile memory 232, and store resulting data in non-volatile memory 234. According to an embodiment, the processor 220 may include a main processor 221 (e.g., a central processing unit (CPU) or an application processor (AP)), and an auxiliary processor 223 (e.g., a graphics processing unit (GPU), an image signal processor (ISP), a sensor hub processor, or a communication processor (CP)) that is operable independently from, or in conjunction with, the main processor 221. Additionally or alternatively, the auxiliary processor 223 may be adapted to consume less power than the main processor 221, or to be specific to a specified function. The auxiliary processor 223 may be implemented as separate from, or as part of the main processor 221.

The auxiliary processor 223 may control at least some of functions or states related to at least one component (e.g., the display device 260, the sensor module 276, or the communication module 290) among the components of the electronic device 201, instead of the main processor 221 while the main processor 221 is in an inactive (e.g., sleep) state, or together with the main processor 221 while the main processor 221 is in an active state (e.g., executing an application). According to an embodiment, the auxiliary processor 223 (e.g., an image signal processor or a communication processor) may be implemented as part of another component (e.g., the camera module 280 or the communication module 290) functionally related to the auxiliary processor 223.

The memory 230 may store various data used by at least one component (e.g., the processor 220 or the sensor module 276) of the electronic device 201. The various data may include, for example, software (e.g., the program 240) and input data or output data for a command related thereto. The memory 230 may include the volatile memory 232 or the non-volatile memory 234.

The program 240 may be stored in the memory 230 as software, and may include, for example, an operating system (OS) 242, middleware 244, or an application 246.

The input device 250 may receive a command or data to be used by other component (e.g., the processor 220) of the electronic device 201, from the outside (e.g., a user) of the electronic device 201. The input device 250 may include, for example, a microphone, a mouse, a keyboard, or a digital pen (e.g., a stylus pen).

The sound output device 255 may output sound signals to the outside of the electronic device 201. The sound output device 255 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 260 may visually provide information to the outside (e.g., a user) of the electronic device 201. The display device 260 may include, for example, a display, a hologram device, or a projector and control circuitry to control a corresponding one of the display, hologram device, and projector. According to an embodiment, the display device 260 may include touch circuitry adapted to detect a touch, or sensor circuitry (e.g., a pressure sensor) adapted to measure the intensity of force incurred by the touch.

The audio module 270 may convert a sound into an electrical signal and vice versa. According to an embodiment, the audio module 270 may obtain the sound via the input device 250, or output the sound via the sound output device 255 or a headphone of an external electronic device (e.g., an electronic device 202) directly (e.g., wiredly) or wirelessly coupled with the electronic device 201.

The sensor module 276 may detect an operational state (e.g., power or temperature) of the electronic device 201 or an environmental state (e.g., a state of a user) external to the electronic device 201, and then generate an electrical signal or data value corresponding to the detected state. According to an embodiment, the sensor module 276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 277 may support one or more specified protocols to be used for the electronic device 201 to be coupled with the external electronic device (e.g., the electronic device 202) directly (e.g., wiredly) or wirelessly. According to an embodiment, the interface 277 may include, for example, a high definition multimedia interface (HDMI), a universal serial bus (USB) interface, a secure digital (SD) card interface, or an audio interface.

A connecting terminal 278 may include a connector via which the electronic device 201 may be physically connected with the external electronic device (e.g., the electronic device 202). According to an embodiment, the connecting terminal 278 may include, for example, a HDMI connector, a USB connector, a SD card connector, or an audio connector (e.g., a headphone connector).

The haptic module 279 may convert an electrical signal into a mechanical stimulus (e.g., a vibration or a movement) or electrical stimulus which may be recognized by a user via his tactile sensation or kinesthetic sensation. According to an embodiment, the haptic module 279 may include, for example, a motor, a piezoelectric element, or an electric stimulator.

The camera module 280 may capture a still image or moving images. According to an embodiment, the camera module 280 may include one or more lenses, image sensors, image signal processors, or flashes.

The power management module 288 may manage power supplied to the electronic device 201. According to one embodiment, the power management module 288 may be implemented as at least part of, for example, a power management integrated circuit (PMIC).

The battery 289 may supply power to at least one component of the electronic device 201. According to an embodiment, the battery 289 may include, for example, a primary cell which is not rechargeable, a secondary cell which is rechargeable, or a fuel cell.

The communication module 290 may support establishing a direct (e.g., wired) communication channel or a wireless communication channel between the electronic device 201 and the external electronic device (e.g., the electronic device 202, the electronic device 204, or the server 208) and performing communication via the established communication channel. The communication module 290 may include one or more communication processors that are operable independently from the processor 220 (e.g., the AP) and supports a direct (e.g., wired) communication or a wireless communication. According to an embodiment, the communication module 290 may include a wireless communication module 292 (e.g., a cellular communication module, a short-range wireless communication module, or a global navigation satellite system (GNSS) communication module) or a wired communication module 294 (e.g., a local area network (LAN) communication module or a power line communication (PLC) module). A corresponding one of these communication modules may communicate with the external electronic device via the first network 298 (e.g., a short-range communication network, such as Bluetooth™, wireless-fidelity (Wi-Fi) direct, or infrared data association (IrDA)) or the second network 299 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 292 may identify and authenticate the electronic device 201 in a communication network, such as the first network 298 or the second network 299, using subscriber information (e.g., international mobile subscriber identity (IMSI)) stored in the SIM 296.

The antenna module 297 may transmit or receive a signal or power to or from the outside (e.g., the external electronic device) of the electronic device 201. According to an embodiment, the antenna module 297 may include an antenna including a radiating element composed of a conductive material or a conductive pattern formed in or on a substrate (e.g., printed circuit board (PCB)). According to an embodiment, the antenna module 297 may include a plurality of antennas. In such a case, at least one antenna appropriate for a communication scheme used in the communication network, such as the first network 298 or the second network 299, may be selected, for example, by the communication module 290 (e.g., the wireless communication module 292) from the plurality of antennas. The signal or the power may then be transmitted or received between the communication module 290 and the external electronic device via the selected at least one antenna. According to an embodiment, another component (e.g., a radio frequency integrated circuit (RFIC)) other than the radiating element may be additionally formed as part of the antenna module 297.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 201 and the external electronic device 204 via the server 208 coupled with the second network 299. Each of the electronic devices 202 and 204 may be a device of a same type as, or a different type, from the electronic device 201. According to an embodiment, all or some of operations to be executed at the electronic device 201 may be executed at one or more of the external electronic devices 202, 204, or 208. For example, if the electronic device 201 should perform a function or a service automatically, or in response to a request from a user or another device, the electronic device 201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 201. The electronic device 201 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 240) including one or more instructions that are stored in a storage medium (e.g., internal memory 236 or external memory 238) that is readable by a machine (e.g., the electronic device 201). For example, a processor (e.g., the processor 220) of the machine (e.g., the electronic device 201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

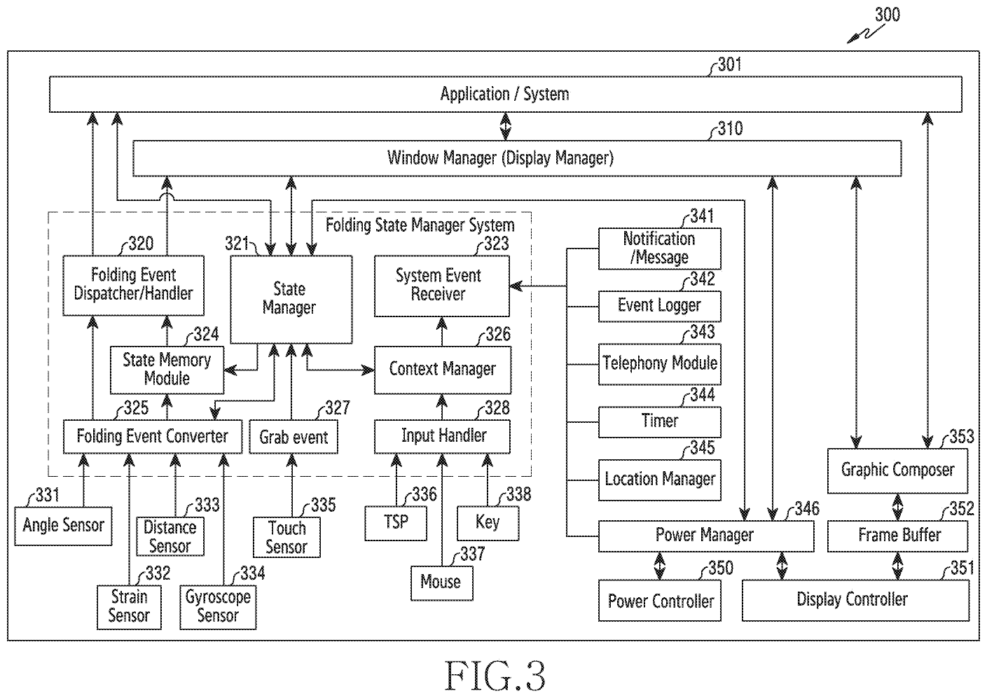

FIG. 3 is a block diagram of a program module according to an embodiment of the disclosure. According to an embodiment, the program module 300 may be the program 240 of the electronic device 201 of FIG. 2.

Referring to FIG. 3, according to various embodiments, the program module 300 may include an operating system for controlling resources related to the electronic device 201 and/or various applications executed on the operating system. The operating system may include, for example, Android™, iOS™, Windows™, Symbian™, Tizen™, or Bada™. At least part of the program module 300, for example, may be pre-loaded on the electronic device, or downloaded from an external electronic device (e.g., the electronic device 204, the server 208 of FIG. 2).

According to various embodiments, a folding event converter 325 (or an event converter) may determine a folding state of the electronic device by analyzing raw data received from at least one sensor (e.g., an angle sensor 331, a strain sensor 332, a distance sensor 333, or a gyroscope sensor 334). Hereinafter, “folding” may be referred to as “bending”, and “folding event” may be referred to as a “folding gesture”. According to an embodiment, the folding state may indicate the angle between the first surface and the second surface of the electronic device, or a designated angle range corresponding to the angle between the first surface and the second surface of the electronic device. For example, the folding state may indicate which one of a designated first angle range (e.g., greater than 180 degrees), a designated second angle range (e.g., greater than 0 degree and less than 180 degrees), and a designated third angle range (e.g., 0 degree) the angle between the first surface and the second surface of the electronic device corresponds to. The designated angle ranges are exemplary to facilitate the understanding, and the disclosure is not limited to them. According to various embodiments, the designated angle ranges may be set and/or changed by a designer and/or a user. According to an embodiment, the folding state may be expressed by increase or decrease of the folding angle.

According to various embodiments, a state manager 321 may collect state information of the electronic device by communicating with at least one other component (e.g., the folding event converter 325, a grab event manager 327, or a context manager 326), and provide the collected information to at least one other component (e.g., a state memory module 324, an application 301, a window manager 310, etc.). The state information of the electronic device may include at least one of folding state information, grip information, hovering input information, or user touch input information. According to various embodiments, the state memory module 324 may store the state information of the electronic device.

According to various embodiments, a folding event dispatcher 320 (or an event handler) may provide the folding state information of the electronic device to the window manager 310 or the application 301.

According to various embodiments, a notification/message manager 341 may provide the user with an event such as an incoming message, an appointment, or a proximity notification. According to various embodiments, an event logger 342 may record events, and display the events in chronological order. According to various embodiments, a telephony module 343 may manage a voice/video call function of the electronic device. A timer 344 may provide a timer function. According to various embodiments, a location manager 345 may manage, for example, location information of the electronic device. According to various embodiments, a power manager 346 may manage a capacity of a battery or power in conjunction with, for example, a power controller 350, and provide power information required for operating the electronic device.

According to various embodiments, a system event receiver 323 may receive an event from the notification/message manager 341, the event logger 342, the telephony module 343, the timer 344, or the power manager 346, and forward the received event to the context manager 326. According to various embodiments, an input handler 328 may receive an input from a touch sensitive panel (TSP) 336, a mouse 337, or a key 338, and forward the received input to the context manager 326. According to various embodiments, the context manager 326 may manage a system service, based on an input, a system event, a folding state, and so on.

According to various embodiments, the grab event manager 327 may receive grip state information (e.g., a touch input area and/or a position) of the electronic device from a touch sensor 335, and forward the information to the state manager 321.

According to various embodiments, a display controller 351 may control screen on/off. A frame buffer 352 may store pixel values or pixel color values to be outputted to the display. A graphic composer 353 may generate a screen including various objects such as an item, an image, and text.

According to various embodiments, a window manager 310 may manage graphical input interface (GUI) resources used for the screen.

According to various embodiments, the application 301 may include applications which provide, for example, a home, a dialer, a short message service (SMS)/multimedia messaging service (MIMS), an instant message (IM), a browser, a camera, an alarm, a contact, a voice dial, an email, a calendar, a media player, an album, a watch, health care (e.g., which measures an exercise quantity, a blood sugar level, or the like), or environmental information (e.g., atmospheric pressure, humidity, or temperature information).

At least part of the program module may be implemented (e.g., executed) in software, firmware, hardware (e.g., a processor), or at least two combinations thereof, and may include a module, a program, a routine, a set of instructions, or a process for performing one or more functions.

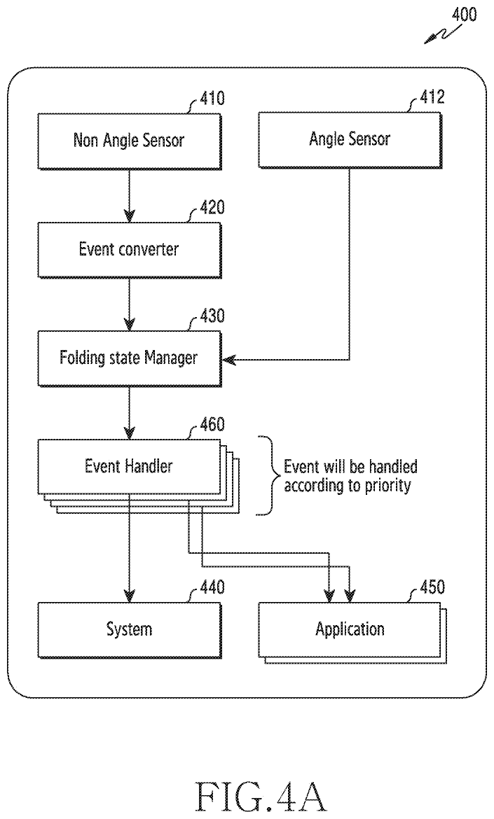

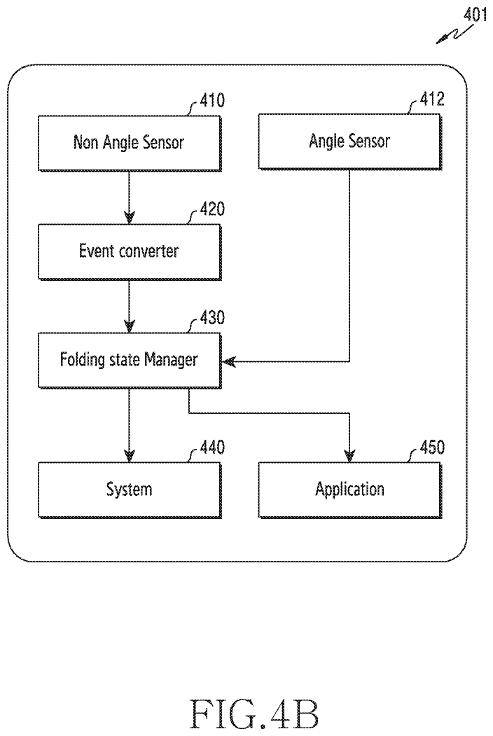

FIGS. 4A and 4B illustrate a program module 400 or 401 for detecting and processing a folding state in an electronic device according to various embodiments of the disclosure.

According to an embodiment, the program module 400 or 401 of FIG. 4A and FIG. 4B may be the program 240 of the electronic device 201 of FIG. 2. According to an embodiment, the program module 400 or 401 of FIGS. 4A and 4B may be at least part of the program module 300 of FIG. 3.

Referring to FIG. 4A, an event converter 420 (e.g., the folding event converter 325 of FIG. 3) may determine (or calculate) a folding state by analyzing raw data provided from a non-angle sensor 410 (e.g., the strain sensor 332, the distance sensor 333, or the gyroscope sensor 334 of FIG. 3). The folding state may indicate the angle between the first surface and the second surface of the electronic device, or the designated angle range corresponding to the angle between the first surface and the second surface of the electronic device. The folding state may indicate which one of a designated first angle range (e.g., greater than 180 degrees), a designated second angle range (e.g., greater than 0 degree and less than 180 degrees), and a designated third angle range (e.g., 0 degree) the angle between the first surface and the second surface of the electronic device corresponds to. The designated angle ranges are exemplary to facilitate the understanding, and the disclosure is not limited thereto. According to various embodiments, the designated angle ranges may be set and/or changed by the designer and/or the user. According to an embodiment, the folding state may represent increase or decrease of the folding angle. According to an embodiment, the event converter 420 may calculate a folding angle between the first surface and the second surface of the electronic device, based on data provided from a gyroscope sensor mounted on the first surface of the electronic device and data provided from a gyroscope sensor mounted on the second surface of the electronic device. The data provided from the gyroscope sensor may indicate an angle between the surface of the corresponding gyroscope sensor and a ground. According to an embodiment, based on data provided from a distance sensor mounted on the first surface of the electronic device and data provided from a distance sensor mounted on the second surface of the electronic device, the event converter 420 may calculate a distance between the first surface and the second surface of the electronic device and calculate a folding angle of the electronic device 201 based on the calculated distance. For example, since the distance between the first surface and the second surface of the electronic device is proportional to the folding angle of the first surface and the second surface of the electronic device, the folding angle corresponding to the distance may be calculated using a preset function.

A folding state manager 430 (e.g., the state manager 321 of FIG. 3) may determine whether an event occurs according to the folding state, based on folding state information provided from the event converter 420 and/or angle information provided from an angle sensor 412. The folding state manager 430 may provide the event occurrence based on the folding state to an event handler 460. The event based on the folding state may be processed by the event handler 460. The event handler 460 may be registered by various modules such as a system 440, an application 450 (e.g., the application 301 of FIG. 3), and a background service, and the registered event handler 460 may process the event based on the folding state according to a priority. For example, the priority may be determined in order of the system 440, a visible (or activated) application, an application which is being executed but is not directly visible to the user, and a background service which does not have a visible user interface. For example, if the event based on the folding state is not processed by the event handler of a high priority, the event based on the folding state may be processed by the event handler having a next priority.

According to an embodiment, the system 440 may identify the folding state of the electronic device based on an event processing request of the event handler 460, and provide the application 450 with display position information of at least one object based on the folding state. According to an embodiment, based on the event processing request of the event handler 460, the system 440 may identify a situation (e.g., a landscape mode) which satisfies a designated condition of not processing the folding event, and may not process the folding event. For example, if the electronic device 101 is in the landscape mode, the system 440 may ignore the folding event, not to change the display position of at least one object due to the folding event. According to an embodiment, the application 450 may control the display position of at least one object, based on the event processing request of the event handler 460. According to an embodiment, based on the event processing request of the event handler 460, the application 450 may control to split and display at least part of an application screen.

It has been described that, but not limited to, the folding event is not processed in the landscape by way of example. For example, according to an embodiment, the system 440 may process the folding event even in the landscape mode, depending on a design. For example, if a folding event occurs in the landscape mode of the electronic device 101, the system 440 may process the folding event to control the display position of at least one object in response to the folding event.

Referring to FIG. 4B, the folding state manager 430 forwards the event based on the folding state directly to the system 440 or the application 450, without passing through the event handler. For example, the folding state manager 430 may determine whether to forward the event based on the folding state and/or a target to which the event is forwarded, based on context information of the electronic device obtained from a context manager (the context manager 326 of FIG. 3).

According to various embodiments, a processor (e.g., the processor 220 of FIG. 2) may detect a folding state of the electronic device using at least one sensor (e.g., the sensor module 276), and control a user interface based on the folding state of the electronic device. According to an embodiment, the processor 220 may determine the folding state indicating a mechanical state of the electronic device 201, based on data received from the sensor module 276. For example, the processor 220 may determine (or calculate) an angle between a first surface of a first housing (e.g., the first housing 112 of FIG. 1) and a second surface of a second housing (e.g., the second housing 114 of FIG. 1) of the electronic device 201, based on at least one of an angle sensor, a strain sensor, a distance sensor, or a gyroscope sensor of the electronic device 201. According to an embodiment, the processor 220 may determine which one of a designated first angle range (e.g., 180 degrees), a designated second angle range (e.g., greater than 0 degree and less than 180 degrees), and a designated third angle range (e.g., 0 degree) the angle between the first surface of the first housing and the second surface of the second housing corresponds to. If the angle between the first surface of the first housing and the second surface of the second housing corresponds to the designated first angle range, the processor 220 may determine a folded out state of the electronic device 201. If the angle between the first surface of the first housing and the second surface of the second housing corresponds to the designated second angle range, the processor 220 may determine a folded in state of the electronic device 201. If the angle between the first surface of the first housing and the second surface of the second housing corresponds to the designated third angle range, the processor 220 may determine a closed state of the electronic device 201.

According to various embodiments, the processor 220 may control to provide any one of a first user interface or a second user interface corresponding to a running application based on the folding state of the electronic device. For example, the processor 220 may control to provide the first user interface corresponding to the running application if the electronic device is folded out, and control to provide one of the first user interface or the second user interface corresponding to the running application if the electronic device is folded in. The second user interface includes the same object as the first user interface, but a display position of at least one object may be different from the first user interface. For example, the first user interface may display at least one main object in a first area of the display, whereas the second user interface may display at least one main object in a second area which is a different area of the display. According to an embodiment, at least part of the second area may overlap at least part of the first area. According to an embodiment, the second area may not overlap the first area. According to an embodiment, the display area and/or the position of the at least one main object in the second user interface may be changed based on at least one of a grip mode of the electronic device, a position of a detected hovering input, a user preferred direction, or a mainly used direction.

According to various embodiments, if the electronic device is folded out, the processor 220 may control a display (e.g., the display 130 of FIG. 1 or the display device 260 of FIG. 2) to provide the first user interface corresponding to the running application. For example, if the electronic device is folded out and a home application is running, the processor 220 may control to display a first home screen on the display. For example, if the electronic device is folded out and a camera application is running, the processor 220 may control to display a first screen (e.g., a preview screen, a video recording screen, or a camera setting screen) of the camera application on the display. According to an embodiment, the first user interface corresponding to the running application may include at least one of an object or content. The object may include may include an item (e.g., a menu item, a popup window, a function button, or an icon) for triggering at least one designated function. According to an embodiment, the content may include at least one of an image or a text. For example, the first user interface (e.g., the first home screen) corresponding to the home application may include at least one of a home button, a back button, a recent use history button, at least one application icon, or a background image. For example, the first user interface (e.g., the first screen) corresponding to the camera application may include at least one of an image capturing button, a video recording button, a captured image view button, a shooting mode switch button, a flash setting button, a camera setting menu entry button, or preview images obtained from the camera module 280 in real time.

According to various embodiments, if the electronic device is changed from the folded out state to the folded in state, the processor 220 may determine whether to change the user interface, based on whether at least one main object exists in the first user interface corresponding to the running application. According to various embodiments, if the application is executed in the folded in state of the electronic device, the processor 220 may determine whether to maintain the first user interface or to switch to the second user interface, based on whether at least one main object exists in the first user interface corresponding to the running application. The main object may include at least one of an object displayed in a first area of the display in the folded out state of the electronic device 201, an object pre-designated by a designer, a designated object in the application, or an object of which use frequency exceeds a designated threshold. According to an embodiment, the first area of the display may include at least part of an area corresponding to the position of the folding portion 120 in the whole area of the display 130. For example, the first area of the display may be an area where a left area corresponding to the first surface and a right area corresponding to the second surface meets in the entire area of the display meet. The first area of the display may include at least part of the area corresponding to the folding portion of the display 130. The first area of the display may include at least part of the left area corresponding to the first surface of the display and at least part of the right area corresponding to the second surface of the display. The first area of the display may be set and/or changed by the designer and/or the user. According to an embodiment, if there is no at least one main object in the first user interface, the processor 220 may maintain the first user interface without changing the user interface. For example, if there is no at least one main object in the first user interface, the processor 220 may maintain the first user interface corresponding to the running application, in response to an event which changes the electronic device from the folded out state to the folded in state.

According to an embodiment, if at least one main object exists in the first user interface, the processor 220 may change the user interface for the running application from the first user interface to the second user interface. For example, by changing the display area (or position) of at least one main object in the first user interface, the processor 220 may provide the second user interface of the changed display area of the main object. For example, in response to an event which changes the electronic device from the folded out state to the folded in state, the processor 220 may move and display at least one main object of the first area to the second area. The second area may be a different area not overlapping the first area.

According to an embodiment, the processor 220 may determine the second area for displaying the moved main object, based on the grip mode of the electronic device 201 and/or the area of the detected hovering input. The grip mode may indicate whether the electronic device 201 is held with one hand or two hands. The grip mode may be divided into, for example, a one-hand grip mode and a two-hand grip mode. The processor 220 may determine the grip mode based on a contact area size or a contact position detected by a touch sensor. According to an embodiment, in the one-hand grip mode, the processor 220 may determine at least part of a display area corresponding to the grip surface of the first surface and the second surface of the electronic device 201, as the second area. For example, if the user grips the first surface, the processor 220 may determine at least part of an area not overlapping the first area in the left area of the display corresponding to the first surface, as the second area. For example, if the user grips the second surface, the processor 220 may determine at least part of an area not overlapping the first area in the right area of the display corresponding to the second surface, as the second area. According to an embodiment, in the two-hand grip mode, the processor 220 may determine the second area based on a user preferred direction. For example, the processor 220 may determine the user preferred direction based on a preset main object display direction or a mainly used direction, and determine the second area based on the determined user preferred direction. According to an embodiment, the processor 220 may request the user to preset the main object display direction for the two-hand grip mode, and preset the main object display direction based on a user input. The main object display direction may be set to one of a left direction, a right direction, an up direction, a down direction, a first direction, a second direction, or a bi-direction. If the preset main object display direction is the left direction in the two-hand grip mode, the processor 220 may determine at least partial area not overlapping the first area in the left area of the display corresponding to the first surface in the left direction based on a folding portion (e.g., the folding portion 120 of FIG. 1), as the second area. If the preset main object display direction is the bi-direction in the two-hand grip mode, the processor 220 may determine the second area in each of the left area and the second area of the display. For example, if the preset main object display direction is the bi-direction, the processor 220 may determine at least partial area not overlapping the first area in the left area of the display as the second area, and determine at least partial area not overlapping the first area in the right area of the display as the second area. If determining two second areas, the processor 220 may display the same main object in each of the second areas. According to an embodiment, the processor 220 may determine a direction mainly used by the user based on a shape change of the contact area detected by the touch sensor, or a hovering input detection position, and determine the second area based on the determined direction. For example, if the shape change of the contact area of the left direction of the display is more frequent than the shape change of the contact area of the right direction in the two-hand grip mode, the processor 220 may determine the right direction as the mainly used direction. For example, if hovering inputs detected in the left direction of the display are more than hovering inputs detected in the right direction of the display in the two-hand grip mode, the processor 220 may determine the left direction as the mainly used direction. The processor 220 may determine at least partial area not overlapping the first area of the display area corresponding to the surface of the mainly used direction based on the folding portion (e.g., the folding portion 120 of FIG. 1), as the second area. According to an embodiment, the main object display direction or the mainly used direction may be set and/or determined for each application. For example, the main object display direction for the home screen application may be set to the bi-direction, and the main object display direction for the camera application may be set to the right direction. For example, the mainly used direction for the home screen application may be set to the right direction, and the mainly used direction for the camera application may be set to the left direction. According to an embodiment, the mainly used direction may be re-determined (or updated) at a periodic or designated event occurrence. If the mainly used direction is changed, the processor 220 may change the second area which is the main object display area, based on the changed mainly used direction. For example, the processor 220 may determine the mainly used direction, based on the contact area shape changes and the hovering inputs which are accumulated for a preset time period. If the mainly used direction is changed, the processor 220 may re-determine the second area based on the changed mainly used direction, and control to display the main object in the re-determined second area.

According to an embodiment, the processor 220 may detect a state in which the user grips the first area where the first surface and the second surface meet (or a state in which a center area of the display is gripped). If detecting the gripped state of the first area, the processor 220 may detect the area for displaying the moved main object as the second area, based on at least one of the hand holding the first area (e.g., the left hand or the right hand) or the user preferred direction. According to an embodiment, the processor 220 may determine whether the first area of the display is gripped with the left hand or the right hand, based on at least one of a contact area position, a contact area size, or a contact area shape detected by the touch sensor. For example, if the first area of the display is gripped with the right hand, the processor 220 may determine at least partial area not overlapping the first area in the right area of the display, as the second area. If the first area of the display is gripped with the left hand, the processor 220 may determine at least partial area not overlapping the first area in the left area of the display, as the second area. According to an embodiment, the processor 220 may determine the user preferred direction based on a preset main object display direction for the first area grip state (or the center grip state) or the mainly used direction. By requesting the user to preset the main object display direction for the first area grip state, the processor 220 may preset the main object display direction for the first area grip state based on a user input. If the first area is gripped and the preset main object display direction for the first area grip state is the left direction, the processor 220 may determine at least partial area not overlapping the first area in the left area of the display, as the second area. The processor 220 may determine the direction mainly used by the user, based on the contact area shape change detected by the touch sensor, or a hovering input detection position. If the first area of the display is gripped and the mainly used direction is the right direction, the processor 220 may determine at least partial area not overlapping the first area in the right area of the display, as the second area. The examples of determining the second area if the first area is gripped are to ease the understanding, and the disclosure is not limited thereto.

According to an embodiment, the processor 220 may determine a position, a size and a shape of the second area, by further considering at least one of a sub-object display area in the first user interface corresponding to a running application, or a content display area. For example, the processor 220 may determine at least one of the position, the size and the shape of the second area, wherein the second area for displaying the moved main object does not overlap the sub-object display area. According to an embodiment, the sub-object may include at least one of an object displayed in other area than the first area of the display, an object designated by the designer as the sub-object, an object designated as the sub-object in the application, or an object of which a use frequency is lower than a designated threshold.

According to an embodiment, the processor 220 may adjust at least one of the position, the size and the shape of the sub-object, based on at least one of the position, the size, and the shape of the second area to which the main object is moved. For example, the processor 220 may adjust at least one of the position, the size and the shape of the sub-object, wherein a sub-object display area and a main object display area do not overlap. According to an embodiment, the processor 220 may adjust the display position of the sub-object to display the sub-object in the same direction as the main object. For example, the processor 220 may move the main object from the first area of the display to the left area of the display, and move the sub-object displayed in the right area of the display to the left area of the display. According to an embodiment, the processor 220 may control to display the sub-object in the same direction as the main direction, based on the use frequency of the sub-object. For example, if the use frequency of a first sub-object is higher than a designated use frequency, the processor 220 may control to display the first sub-object in the same direction as the main direction. For example, if the use frequency of the first sub-object is higher than the designated use frequency, the processor 220 may control to display the first sub-object in the same direction as the main direction by moving the main object from the first area of the display to the right area of the display and moving the first sub-object displayed in the left area of the display to the right area of the display. For example, if the use frequency of a second sub-object is lower than the designated use frequency, the processor 220 may maintain a display area of the second sub-object, regardless of the movement direction of the main object. For example, if the use frequency of the second sub-object is lower than the designated use frequency, the processor 220 may move the main object from the first area of the display to the right area of the display and maintain the second sub-object displayed in the left area of the display without changing it.

According to an embodiment, the processor 220 may adjust at least one of a size, a shape, or a color of at least one main object, based on the determined position, size, and shape of the second area. According to an embodiment, with a plurality of main objects, the processor 220 may change arrangement of the main objects based on the second area.

According to an embodiment, the processor 220 may provide an additional object allowing the user to directly change the main object display area. For example, if the main object is moved and displayed in other area than the first area of the display due to the folding state of the electronic device, the processor 220 may display an additional object allowing the user to change the display area and/or the direction of the main object. If the additional object is selected by a user input, the processor 220 may change the main object display area to an opposite area based on the folding portion 120. For example, if the additional object is selected with the main object displayed in the left area of the display based on the folding portion 120, the processor 220 may move and display the main object in the right area of the display based on the folding portion 120.

According to various embodiments, if detecting a designated gesture for the main object and/or the sub-object, the processor 220 may change the display area of the main object and/or the sub-object. The designated gesture may include at least one of, for example, drag, double touch, long touch, and press touch, which are exemplary. The designated gesture according to various embodiments of the disclosure is not limited thereto. According to an embodiment, if the main object and/or the sub-object is touched long and dragged, the processor 220 may change the display area of the main object and/or the sub-object based on the drag direction.

According to various embodiments, if the electronic device 201 is changed from the folded in state to the folded out state, the processor 220 may control to change the user interface for the running application from the second user interface to the first user interface.

According to various embodiments, an electronic device may include a hinge, a first housing including a first surface which faces a first direction and a third surface which faces a second direction facing away the first direction, a second housing including a second surface which faces the first direction and a fourth surface which faces the second direction facing away the first direction, and folding with the first housing based on the hinge, a flexible display extending from the first surface to the second surface, at least one sensor circuit for detecting an angle of the first housing and the second housing, and a processor operatively coupled with the flexible display and the sensor circuit, wherein the processor may be configured to, if the angle detected through the sensor circuit corresponds to a designated first range, control the flexible display to display a first user interface corresponding to a running application, and if the angle detected through the sensor circuit corresponds to a designated second range, control the flexible display to display a second user interface corresponding to the running application, wherein the second user interface may include the same object as the first user interface, and displays at least one object displayed in a first area, in a second area in the first user interface, the first area may include a partial area corresponding to a position of the hinge in a whole area of the flexible display, and the second area may be a different area from the first area.

According to various embodiments, the electronic device may further include a touch sensor, wherein the processor may be configured to determine the second area, based on at least one of a contact area detected through the touch sensor and a hovering input detection area.

According to various embodiments, the processor may be configured to determine a grip mode based on the contact area detected through the touch sensor, and determine the second area, based on at least one of the grip mode, a grip direction, a hovering input detection direction, or a user preferred direction, wherein the grip mode may include at least one of a one-hand grip mode or a two-hand grip mode.

According to various embodiments, in the one-hand grip mode, the processor may be configured to determine the second area, based on at least one of the grip direction or the hovering input detection direction.

According to various embodiments, in the two-hand grip mode, the processor may be configured to determine the second area, based on the user preferred direction, and the user preferred direction may include at least one of an object display direction pre-designated by a user or a mainly used direction.

According to various embodiments, the processor may be configured to determine the mainly used direction, based on a hovering input detected for a designated time duration or a contact area shape change.

According to various embodiments, the second user interface may be configured to display the at least one object displayed in the first area, in each of the second area and the third area in the first user interface.

According to various embodiments, the second area and the third area may be areas of different directions based on an area corresponding to the position of the hinge in an area of the flexible display.

According to various embodiments, the processor may be configured to identify at least one sub-object in the first user interface, and adjust a display position of the at least one sub-object in the second user interface, based on a use frequency of the identified sub-object, wherein the sub-object may include an object displayed in other area than the first area in the first user interface.

According to various embodiments, if the angle detected through the sensor circuit corresponds to the designated second range, the processor may be configured to control the flexible display to display an additional object for changing a display area of at least on object in the second user interface.

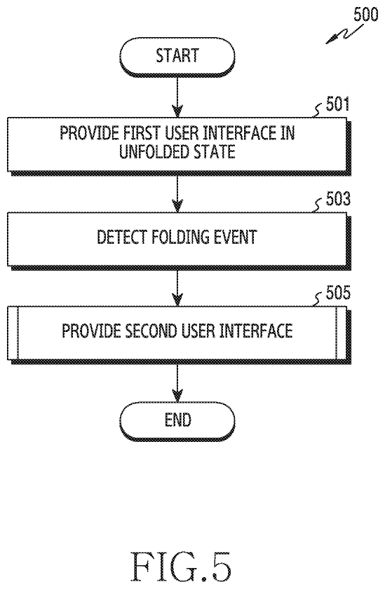

FIG. 5 is a flowchart 500 for controlling a user interface based on a mechanical state change in an electronic device according to an embodiment of the disclosure.

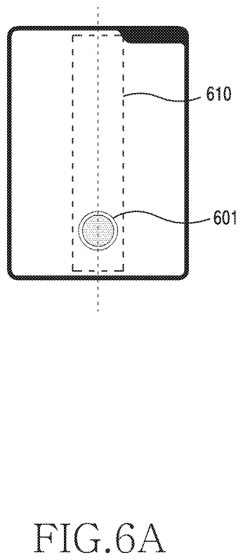

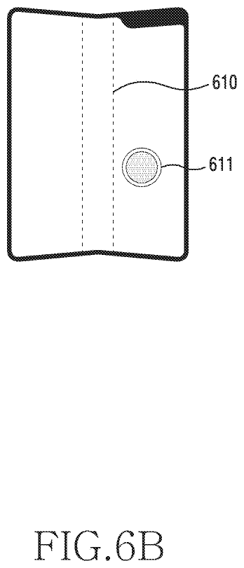

Operations may be or may not be performed in order. For example, order of the operations may be changed, and at least two operations may be performed in parallel. Herein, the electronic device may be the electronic device 101 of FIG. 1 and/or the electronic device 201 of FIG. 2. Now, at least some of the operations of FIG. 5 are described by referring to FIGS. 6A and 6B.

FIGS. 6A and 6B are screen views for controlling a user interface based on a mechanical state change in an electronic device according to various embodiments of the disclosure.

Referring to FIG. 5, an electronic device (e.g., the processor 220 of FIG. 2) according to various embodiments may provide a first user interface corresponding to a running application in an unfolding state (or a folded out state) in operation 501. According to an embodiment, the processor 220 may determine the angle between the first housing 112 and the second housing 114 of the electronic device 101 or 201, using at least one sensor (e.g., the first sensor 141 or the second sensor 142 of FIG. 1, or the sensor module 276 of FIG. 2), and determine whether the electronic device 101 or 201 is unfolded, based on the calculated angle. The unfolding state may indicate that the angle between the first housing 112 and the second housing 114 of the electronic device corresponds to a designated first angle range. The first angle range may include, for example, an angle greater than about 175 degrees and smaller than 185 degrees, which is exemplary to ease the understanding. Notably, the first angle range may be set and/or changed by the designer. According to an embodiment, if the electronic device is folded out, the processor 220 may control a display (e.g., the display 130 of FIG. 1 or the display device 260 of FIG. 2) to provide the first user interface corresponding to the running application. The first user interface corresponding to the running application may include at least one of an object or content. The object may include an item (e.g., a menu item, a popup window, a function button, or an icon) for triggering at least one function relating to the running application. According to an embodiment, the content may include at least one of an image or a text relating to the running application. For example, the first user interface corresponding to a home application may include at least one of a home button, a back button, a recent use history button, at least one application icon, or a background image. For example, the first user interface corresponding to a camera application may include at least one of an image capturing button, a video recording button, a captured image view button, a shooting mode switch button, a flash setting button, a camera setting menu entry button, or preview images obtained from the camera module 280 in real time. According to an embodiment, the first user interface corresponding to the running application may include at least one main object displayed in the first area of the display 130 or 260 with the electronic device 101 or 201 folded out. According to an embodiment, the first area of the display 130 or 260 may include at least part of an area corresponding to a position of a folding portion (e.g., the folding portion 120 of FIG. 1) of the whole area of the display 130 or 260. The first area of the display may be set and/or changed by the designer and/or the user. For example, the processor 220 may control to provide the first user interface displaying a main object 601 in a first area 610 of the display 130 as shown in FIG. 6A.

According to various embodiments, the electronic device (e.g., the processor 220) may detect a folding event in operation 503. According to an embodiment, the processor 220 may determine the angle between the first housing 112 and the second housing 114 of the electronic device 101 or 201, using at least one sensor (e.g., the first sensor 141, the second sensor 142, or the sensor module 276), and detect the folding state of the electronic device 101 or 201, based on the calculated angle. If the angle between the first housing 112 and the second housing 114 corresponds to a designated second angle range, the processor 220 may determine occurrence of the folding event. The second angle range may include, for example, an angle greater than about 5 degrees and smaller than 175 degrees, which is exemplary to ease the understanding. Notably, the second angle range may be set and/or changed by the designer.

According to various embodiments, the electronic device (e.g., the processor 220) may provide the second user interface corresponding to the running application in operation 505. According to an embodiment, in response to detecting folding event, the processor 220 may control a display (e.g., the display 130 or the display device 260) to provide the second user interface corresponding to the running application. According to an embodiment, if the electronic device 101 or 201 is folded in, the processor 220 may control the display (e.g., the display 130 or the display device 260) to provide the second user interface corresponding to the running application. The second user interface corresponding to the running application may include the same object as the first user interface but a display position of at least one main object may be different from the first user interface. For example, the first user interface displays the at least one main object 601 in the first area 610 of the display as shown in FIG. 6B, whereas the second user interface may display at least one main object 611 in the second area which is a different area of the display as shown in FIG. 6B. According to an embodiment, the processor 220 may determine the second area for displaying the main object, based on at least one of a grip mode of the electronic device 101 or 201, a hovering input detection position, a user preferred direction, or a mainly used direction. The second area may be determined to a different area not overlapping the first area in the whole area of the display 130 or 260. According to an embodiment, if the electronic device 101 or 201 is changed from the folded out state to the folded in state, the processor 220 may control the display 130 or 260 to provide an effect which moves at least one main object form the first area to the second area.

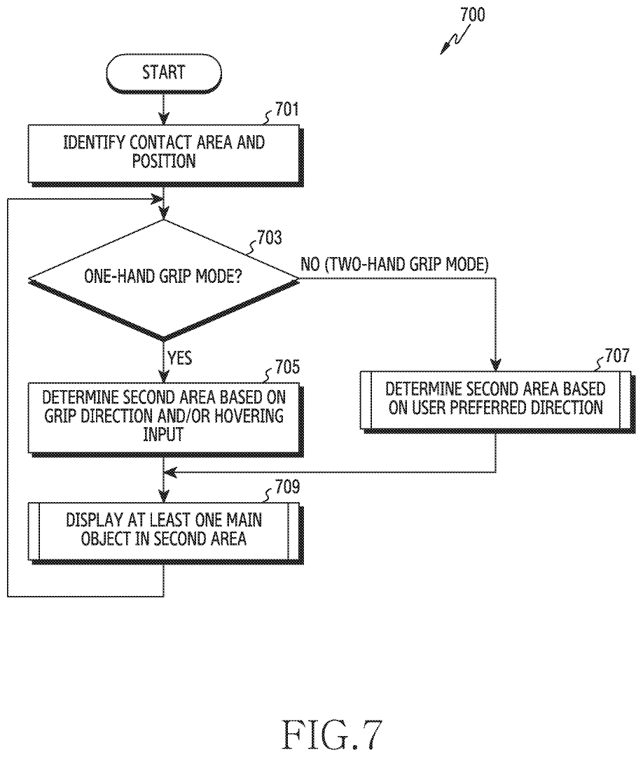

FIG. 7 is a flowchart 700 for controlling a user interface based on a grip mode in an electronic device according to an embodiment of the disclosure.

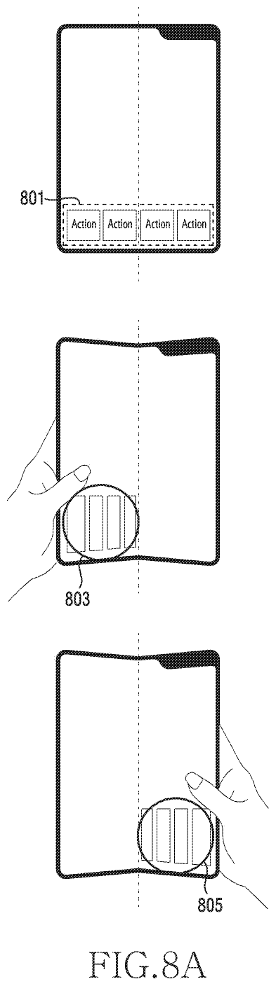

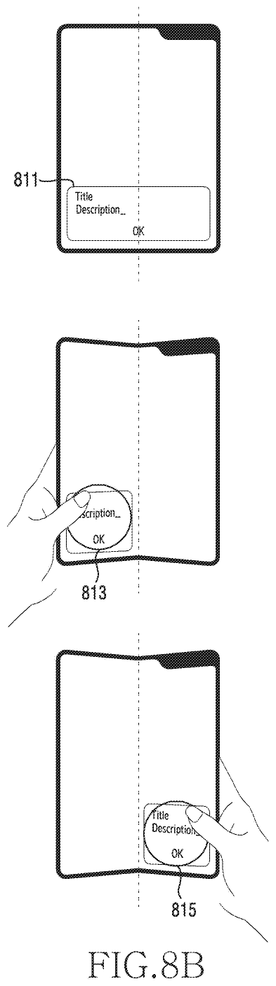

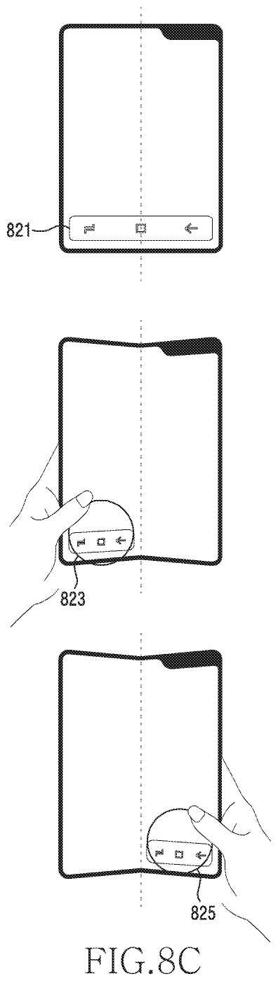

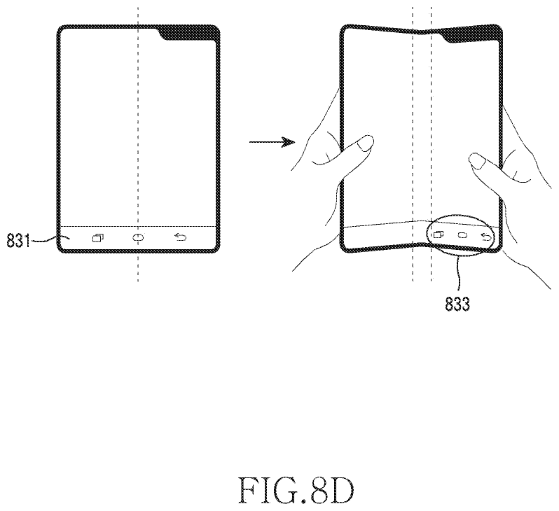

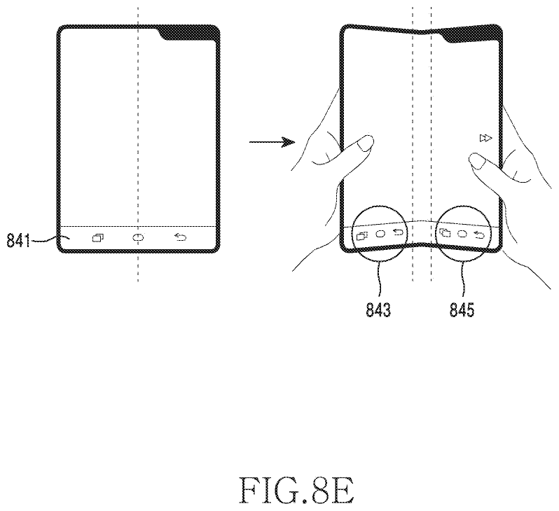

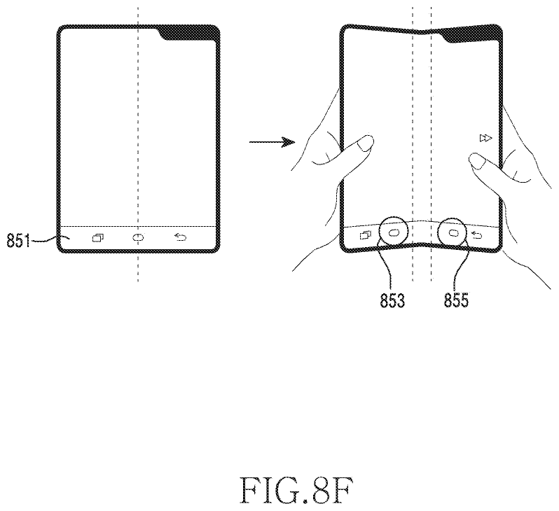

Operations of FIG. 7 may be at least part of detailed operations of operation 505 of FIG. 5. Operations may be or may not be performed in order. For example, the order of the operations may be changed, and at least two operations may be performed in parallel. Herein, the electronic device may be the electronic device 101 of FIG. 1 and/or the electronic device 201 of FIG. 2. Now, at least some of the operations of FIG. 7 are described by referring to FIGS. 8A to 8F.

FIGS. 8A, 8B, 8C, 8D, 8E, and 8F are screen views for controlling a user interface based on a grip mode in an electronic device according to various embodiments of the disclosure.

Referring to FIG. 7, an electronic device (e.g., the processor 220 of FIG. 2) according to various embodiments may identify contact area and position in operation 701. According to an embodiment, the processor 220 may detect a user contact to the electronic device 101 or 201 using at least one sensor (e.g., the sensor module 276 of FIG. 2), and identify the detected contact area and contact position. For example, the processor 220 may identity the contact area and position of a user grip of the electronic device 101 or 201 using a touch sensor which is coupled to or embedded in a display (e.g., the display 130 of FIG. 1 or the display device 260 of FIG. 2).

According to various embodiments, the electronic device (e.g., the processor 220) may determine whether it is in the one-hand grip mode in operation 703. According to an embodiment, the processor 220 may determine the grip mode based on the contact area size and/or the contact position detected using at least one sensor (e.g., the sensor module 276 of FIG. 2). For example, if the user contact is detected only in an area corresponding to a first housing (e.g., the first housing 112 of FIG. 1) of the whole area of the display 130 and the size of the detected contact area is greater than a threshold size, the processor 220 may determine the one-hand grip mode in which the first housing is gripped. For example, if the user contact is detected only in an area corresponding to a second housing (e.g., the second housing 114 of FIG. 1) of the whole area of the display 130 and the size of the detected contact area is greater than the threshold size, the processor 220 may determine the one-hand grip mode in which the second housing is gripped. For example, if the user contact is detected in each of the area corresponding to the first housing 112 and the area corresponding to the second housing 114 of the whole area of the display 130 and the size of each detected contact area is greater than the threshold size, the processor 220 may determine the two-hand grip mode in which both of the first housing and the second housing are gripped. For example, if the user contact is detected in each of the area corresponding to the first housing 112 and the area corresponding to the second housing 114 of the whole area of the display 130 but the size of the detected contact area in the area corresponding to the first housing 112 is greater than the threshold size and the size of the detected contact area in the area corresponding to the second housing 114 is smaller than the threshold size, the processor 220 may determine the one-hand grip mode in which the first housing is gripped. For example, if the contact area size is smaller than the threshold size, the processor 220 may process the corresponding contact as a non-grip touch input.

According to various embodiments, in the one-hand grip mode, the electronic device (e.g., the processor 220) may determine a second area based on the grip direction and/or a hovering input in operation 705, and display at least one main object in the second area in operation 709. According to an embodiment, in the one-hand grip mode, the processor 220 may determine at least one partial area of a surface corresponding to the grip direction in the first surface of the display 130 corresponding to the first housing 112 and the second surface of the display 130 corresponding to the second housing 114, as the second area. For example, if the user grips the first housing 112, the processor 220 may determine at least partial area not overlapping the first area in the left area of the display corresponding to the first surface, as the second area. For example, if the user grips the second housing 114, the processor 220 may determine at least partial area not overlapping the first area in the right area of the display corresponding to the second surface, as the second area. According to an embodiment, in the one-hand grip mode, the processor 220 may determine at least one partial area of the surface of the detected hovering input in the first surface of the display 130 corresponding to the first housing 112 and the second surface of the display 130 corresponding to the second housing 114, as the second area. According to an embodiment, the processor 220 may move and display at least one main object in the determined second area. For example, if a left portion of the electronic device 101 or 201 is gripped and the electronic device 101 or 201 is folded, the processor 220 may display objects 801, 811, and 821 displayed at the bottom including at least part of the first area in the folded out state, in second areas 803, 813, and 823 which are part of the left surface as shown in FIGS. 8A, 8B, and 8C. For example, if a right portion of the electronic device 101 or 201 is gripped and the electronic device 101 or 201 is folded, the processor 220 may display the objects 801, 811, and 821 displayed at the bottom including at least part of the first area in the folded out state, in second areas 805, 815, and 825 which are part of the right surface as shown in FIGS. 8A, 8B, and 8C.

According to various embodiments, in the two-hand grip mode, the electronic device (e.g., the processor 220) may determine the second area based on the user preferred direction in operation 707, and display at least one main object in the second area in operation 709. According to an embodiment, in the two-hand grip mode, the processor 220 may determine the user preferred direction based on a preset main object display direction or a mainly used direction, and determine the second area based on the determined user preferred direction. According to an embodiment, the processor 220 may determine the direction mainly used by the user based on a shape change of the contact area detected by the touch sensor or a hovering input detection position, and determine the mainly used direction as the user preferred direction. The processor 220 may request the user to preset the main object display direction for the two-hand grip mode, and preset the main object display direction based on a user input. The processor 220 may determine the preset main object display direction as the user preferred direction. According to an embodiment, if the user preferred direction is the left direction in the two-hand grip mode, the processor 220 may determine at least part of the left area of the display based on a folding portion (e.g., the folding portion 120 of FIG. 1), as the second area, and control a display (e.g., the display 130 or the display device 260) to display a main object in the second area. For example, as shown in FIG. 8D, if both side portions of the electronic device 101 or 201 are gripped and the electronic device 101 or 201 is folded in, the processor 220 may display objects 831 displayed at the bottom including at least part of the first area in the folded out state, in a second area 833 which is part of the right surface corresponding to the user preferred direction. According to an embodiment, if the user preferred direction is both directions in the two-hand grip mode, the processor 220 may determine the second area in each of the left area and the right area of the display and control the display (e.g., the display 130 or the display device 260) to display a main object in the two second areas of the left area and the right area. For example, as shown in FIG. 8E, if both side portions of the electronic device 101 or 201 are gripped and the electronic device 101 or 201 is folded in, the processor 220 may display objects 841 displayed at the bottom including at least part of the first area in the folded out state, in second areas 843 and 845 which are part of the both surfaces (the first surface and the second surface). For example, as shown in FIG. 8F, if both side portions of the electronic device 101 or 201 are gripped and the electronic device 101 or 201 is folded in, the processor 220 may display an object placed in the first area among objects 851 displayed at the bottom in the folded out state, in second areas 853 and 855 which are part of the both surfaces.

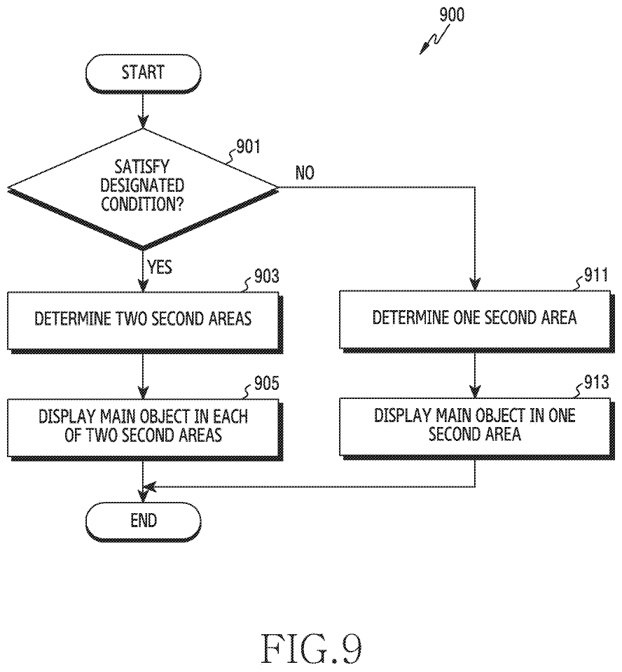

FIG. 9 is a flowchart 900 for controlling a user interface based on a designated condition in an electronic device according to an embodiment of the disclosure.

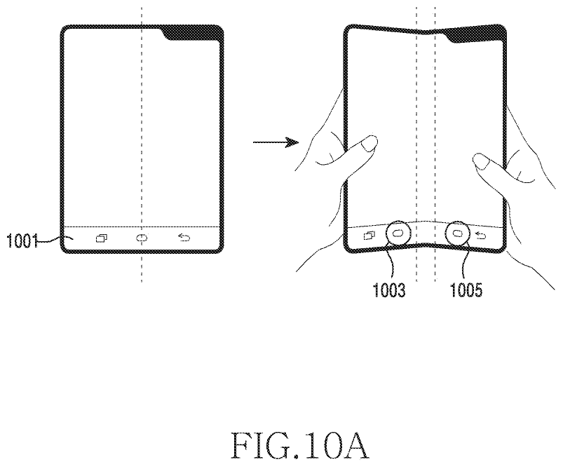

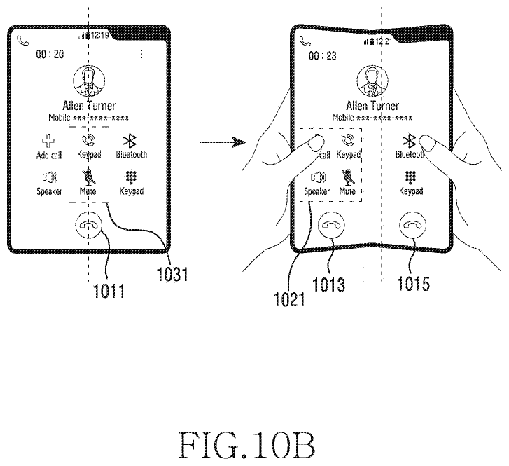

Operations of FIG. 9 may be at least part of detailed operations of operation 707 and operation 709 of FIG. 7. Operations may be or may not be performed in order. For example, the order of the operations may be changed, and at least two operations may be performed in parallel. Herein, the electronic device may be the electronic device 101 of FIG. 1 and/or the electronic device 201 of FIG. 2. Now, at least some of the operations of FIG. 9 shall be described by referring to FIGS. 10A and 10B. FIGS. 10A and 10B are screen views for controlling a user interface based on a designated condition in an electronic device according to various embodiments of the disclosure.

Referring to FIG. 9, an electronic device (e.g., the processor 220 of FIG. 2) may determine whether a designated condition is satisfied in operation 901. According to an embodiment, the designated condition may include a condition of whether a designated main object is included in the first user interface. For example, the processor 220 may determine whether the main object designated to display on both surfaces in the two-hand grip mode exists in at least one object of the first user interface of a running application. If the main object designated to display on both surfaces in the two-hand grip mode is included in the first user interface, the processor 220 may determine that the designated condition is satisfied. If the main object designated to display on both surfaces in the two-hand grip mode is not included in the first user interface, the processor 220 may determine that the designated condition is not satisfied. According to an embodiment, the designated condition may include a condition of whether the running application is a designated application. For example, the processor 220 may determine whether the running application is an application designated to display the main object on both surfaces in the two-hand grip mode. The processor 220 may determine whether the corresponding application is the application designated to display the main object on both surfaces in the two-hand grip mode, based on at least one of a type of the running application, application identification information, or application functionality. For example, if the application designated to display the main object on both surfaces in the two-hand grip mode matches the running application in type, the processor 220 may determine that the designated condition is satisfied. For example, if the application designated to display the main object on both surfaces in the two-hand grip mode does not match the running application in type, the processor 220 may determine that the designated condition is not satisfied. According to an embodiment, the designated condition may include a condition on a use frequency or a use count of the main object included in the first user interface. For example, the processor 220 may determine whether a main object which is used over a threshold count during a preset time period exists in at least one object of the first user interface of the running application. If at least one main object of the first user interface of the running application is used over the threshold count, the processor 220 may determine that the designated condition is satisfied. If main objects of the first user interface of the running application are used in a number of times which is smaller than or equal to the threshold count, the processor 220 may determine that the designated condition is not satisfied.

According to various embodiments, if the designated condition is satisfied, the electronic device (e.g., the processor 220) may determine two second areas in operation 903, and display a main object in each of the two determined areas in operation 905. According to an embodiment, the processor 220 may determine at least part of the first surface of the electronic device 101 or 201 as the second area, determine at least part of the second surface as the second area, and control the display (e.g., the display 130 of FIG. 1 or the display device 260 of FIG. 2) to display at least one main object in each of the two determined second areas. The second area of the first surface and the second area of the second surface may face each other if the electronic device 101 or 201 is closed. The main object displayed in each of the two second areas may include an object to be displayed on both surfaces in the two-hand grip mode. For example, as shown in FIG. 10A, if a home button object of objects 1001 of the first user interface is used over a threshold count, the processor 220 may control to display the home button object in each of a second area 1003 of the first surface and a second area 1005 of the second surface. For example, as shown in FIG. 10B, if a call end button object 1011 of objects of the first user interface corresponding to a call application is a designated object to be displayed on both surfaces in the two-hand grip mode, the processor 220 may control to display the call end button object in each of a second area 1013 of the first surface and a second area 1015 of the second surface.

According to various embodiments, if the designated condition is not satisfied, the electronic device (e.g., the processor 220) may determine one second area in operation 911, and display a main object in the determined second area in operation 913. According to an embodiment, the processor 220 may determine at least part of one of the first surface and the second surface of the electronic device 101 or 201 as the second area, and control the display (e.g., the display 130 of FIG. 1 or the display device 260 of FIG. 2) to display at least one main object in the determined second area. The processor 220 may select one of the first surface and the second surface based on the user preferred direction, and determine at least part of the selected surface as the second area. For example, as shown in FIG. 10B, if the first user interface corresponding to the call application includes main objects 1031 not designated to display on both surfaces in the two-hand grip mode, the processor 220 may control to move and display the corresponding main objects 1031 in a second area 1021 of the first surface based on the user preferred direction. According to an embodiment, if the second area 1021 of the first surface includes sub-objects, the processor 220 may control to display the sub-objects not to overlap the main objects, by adjusting a display position and/or a size of the sub-objects.

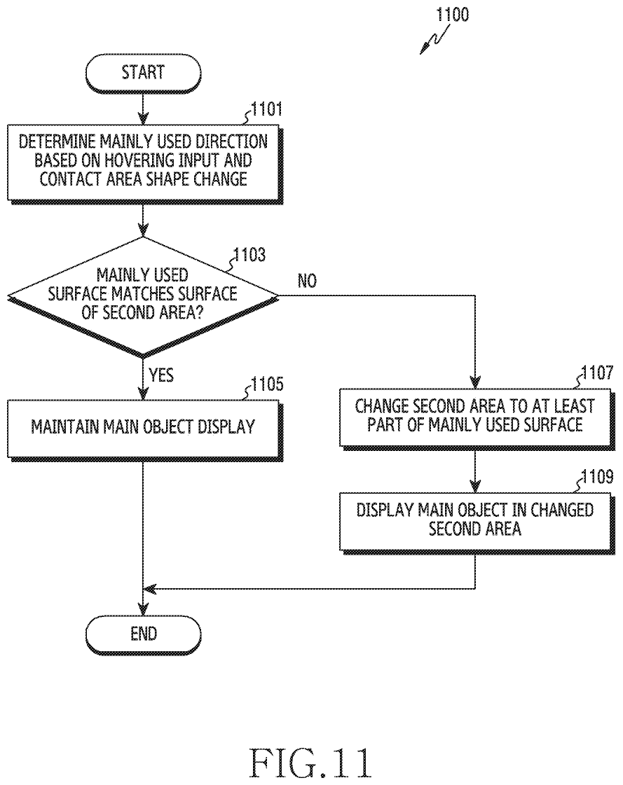

FIG. 11 is a flowchart 1100 for controlling a user interface based on a mainly used surface in an electronic device according to an embodiment of the disclosure.

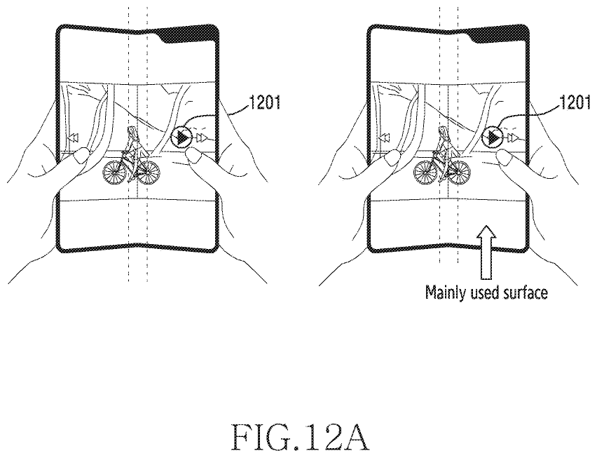

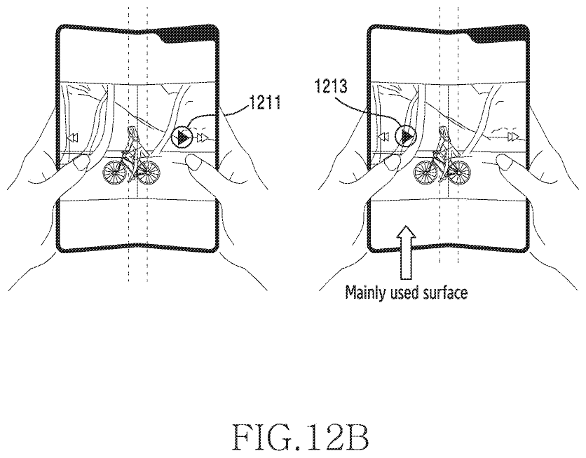

Operations of FIG. 11 may be at least part of detailed operations of operation 707 of FIG. 7. The operations may be or may not be performed in order. For example, the order of the operations may be changed, and at least two operations may be performed in parallel. Herein, the electronic device may be the electronic device 101 of FIG. 1 and/or the electronic device 201 of FIG. 2. Now, at least some of the operations of FIG. 11 shall be described by referring to FIGS. 12A and 12B.

FIGS. 12A and 12B are screen views for controlling a user interface based on a mainly used surface in an electronic device according to various embodiments of the disclosure.

Referring to FIG. 11, the electronic device (e.g., the processor 220) according to various embodiments may determine the mainly used direction based on a hovering input and a contact area shape change in operation 1101. According to an embodiment, the processor 220 may determine the direction mainly used by the user, based on the contact area shape change detected by the touch sensor or the hovering input detection position. For example, if the contact area shape change of the left direction of the display is more frequent than the contact area shape change of the right direction in the two-hand grip mode, the processor 220 may determine the right direction as the mainly used direction. For example, if the number of hovering inputs detected on the first surface in the left direction is greater than the number of hovering inputs detected on the second surface in the right direction in the two-hand grip mode, the processor 220 may determine the left direction as the mainly used direction.

According to various embodiments, the electronic device (e.g., the processor 220) may determine whether a mainly used surface corresponding to the mainly used direction matches the surface of the second area in operation 1103. For example, based on whether the mainly used surface matches the surface of the second area, the processor 220 may determine whether the main object is displayed in the mainly used surface. If the mainly used surface matches the surface of the second area, the processor 220 may determine that the main object is displayed in the mainly used surface. If the mainly used surface does not match the surface of the second area, the processor 220 may determine that the main object is not displayed in the mainly used surface.

According to various embodiments, if the mainly used surface matches the surface of the second area, the electronic device (e.g., the processor 220) may control a display (e.g., the display 130 of FIG. 1 or the display device 260 of FIG. 2) to maintain the main object display in operation 1105. For example, if the mainly used surface matches the surface of the second area, the main object is displayed in the mainly used surface and accordingly the processor 220 may maintain the main object display. For example, as shown in FIG. 12A, if a play button 1201 which is the main object is displayed in the second surface and the mainly used surface is the second surface of the right direction, the play button 1201 is displayed in the mainly used surface and accordingly the processor 220 may maintain the display of the main object.

According to various embodiments, if the mainly used surface does not match the surface of the second area, the electronic device (e.g., the processor 220) may change the second area to at least part of the mainly used surface in operation 1107, and display the main object in the changed second area in operation 1109. For example, if the mainly used surface does not match the surface of the second area, the main object is not displayed in the mainly used surface and accordingly the processor 220 may determine at least part of the mainly used surface as the second area and thus move and display the main objet in the mainly used surface. For example, as shown in FIG. 12B, if a play button 1211 which is the main object is displayed in the second surface and the mainly used surface is the first surface of the left direction, the processor 220 may control to display a play button 1213 in part of the mainly used surface.

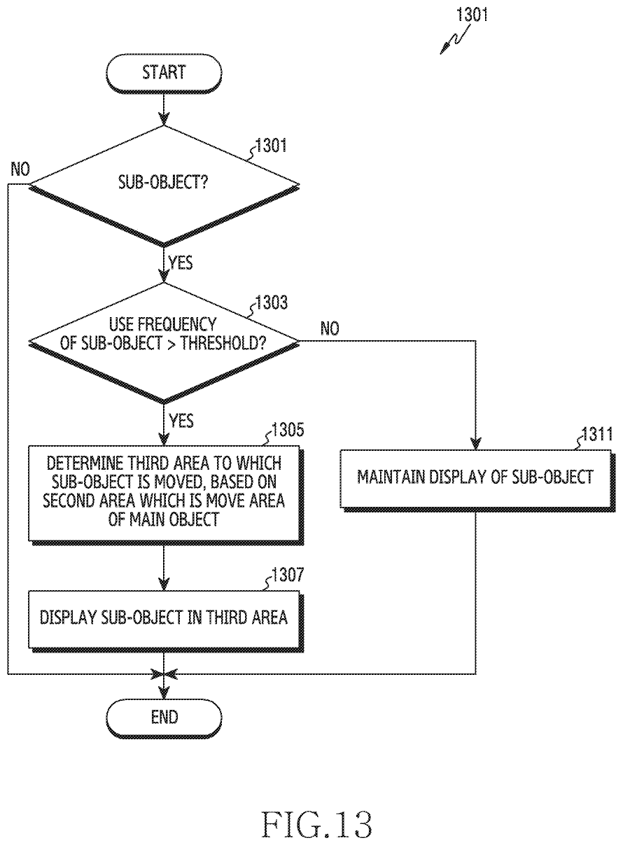

FIG. 13 is a flowchart 1300 for controlling a user interface based on an object use frequency in an electronic device according to an embodiment of the disclosure.

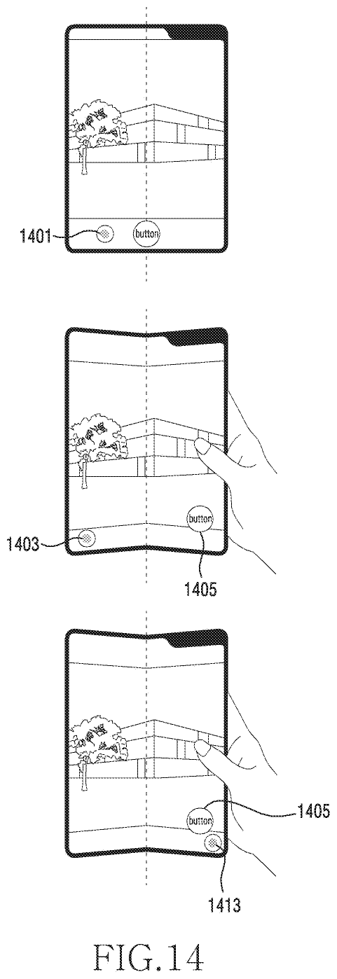

Operations of FIG. 13 may be at least part of detailed operations of operation 505 of FIG. 5. The operations may be or may not be performed in order. For example, the order of the operations may be changed, and at least two operations may be performed in parallel. Herein, the electronic device may be the electronic device 101 of FIG. 1 and/or the electronic device 201 of FIG. 2. Now, at least some of the operations of FIG. 13 shall be described by referring to FIG. 14.

FIG. 14 is a screen view for controlling a user interface based on a use frequency in an electronic device according to an embodiment of the disclosure.

Referring to FIG. 13, the electronic device (e.g., the processor 220) according to various embodiments may determine whether a sub-object exists in the first user interface in operation 1301. According to an embodiment, the sub-object may include at least one of an object displayed in other area than the first area of the display, an object designated by the designer as the sub-object, an object designated as the sub-object in an application, or an object not designated as a main object. For example, the processor 220 may determine whether the first user interface corresponding to a running application includes at least one sub-object.

According to various embodiments, the electronic device (e.g., the processor 220) may compare a use frequency of the sub-object with a designated threshold and determine whether the use frequency of the sub-object is greater than the designated threshold in operation 1303. According to an embodiment, the use frequency of the sub-object may be calculated by accumulating the use count during a preset time period in the electronic device 101 or 201.

According to various embodiments, if the use frequency of the sub-object is smaller than or equal to the designated threshold, the electronic device (e.g., the processor 220) may maintain the display of the sub-object in operation 1311. According to an embodiment, if the use frequency of the sub-object is smaller than or equal to the designated threshold, the use frequency of the sub-object is low and accordingly the processor 220 may maintain the same display position of the sub-object of the second user interface as the display position of the sub-object of the first user interface. For example, as shown in FIG. 14, if a record button 1401 which is the sub-object is included in the first user interface corresponding to a camera application and the use frequency of the record button 1401 is smaller than the threshold, in response to detecting a folding event, the processor 220 may move and display an image capture button 1405 being the main object in the second surface which is gripped and control not to change the display position of the record button 1403 which is the sub-object.

According to various embodiments, if the use frequency of the sub-object is greater than the designated threshold, the electronic device (e.g., the processor 220) may determine a third area to which the sub-object is moved, based on the second area which is the move area of the main object in operation 1305, and display the sub-object in the third area in operation 1307. According to an embodiment, if the use frequency of the sub-object is greater than the designated threshold, the use frequency of the sub-object is high and accordingly the processor 220 may determine the display area of the sub-object by considering the display area of the main object of the second user interface. For example, the processor 220 may determine the third area which is the display area of the sub-object, to display the sub-object having the use frequency greater than the threshold in the same surface as the main object. For example, as shown in FIG. 14, if the record button 1401 being the sub-object is included in the first user interface corresponding to the camera application and the use frequency of the record button 1401 is greater than the threshold, in response to detecting a folding event, the processor 220 may move and display the image capture button 1405 being the main object and a record button 1413 being the sub-object in the second surface which is gripped.

While it has been described that the display position of the sub-object in the user interface is controlled based on the use frequency in FIG. 13, the main object may be controlled in the same manner according to various embodiments. For example, if the use frequency of the main object is smaller than or equal to the threshold, the display position of the main object may be maintained in detecting the folding event. For example, if the use frequency of the main object is greater than the threshold, the display position of the main object in detecting the folding event may be changed according to the grip mode as mentioned in FIG. 7.

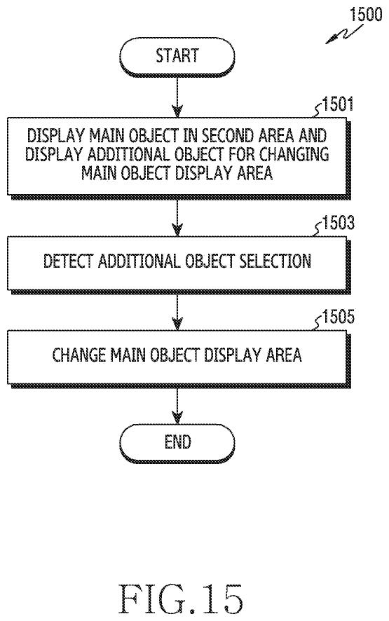

FIG. 15 is a flowchart 1500 for controlling a changed user interface based on a mechanical state change in an electronic device according to an embodiment of the disclosure.

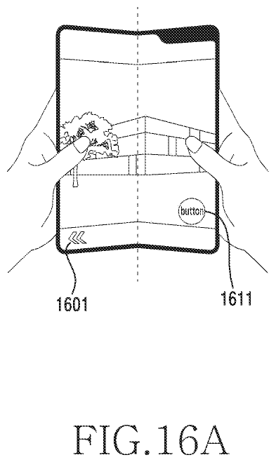

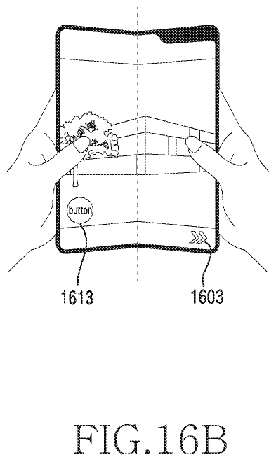

Operations of FIG. 15 may be at least part of detailed operations of operations 705 and 707 of FIG. 7. The operations may be or may not be performed in order. For example, the order of the operations may be changed, and at least two operations may be performed in parallel. Herein, the electronic device may be the electronic device 101 of FIG. 1 and/or the electronic device 201 of FIG. 2. Now, at least some of the operations of FIG. 15 shall be described by referring to FIGS. 16A and 16B.

FIGS. 16A and 16B are screen views for controlling a changed user interface based on a mechanical state change in an electronic device according to various embodiments of the disclosure.

Referring to FIG. 15, the electronic device (e.g., the processor 220) according to various embodiments may display a main object in the second area and display an additional object for changing the main object display area in operation 1501. According to an embodiment, if the electronic device 101 or 201 is folded in the two-hand grip mode, the processor 220 may display the main object in the second area based on the user preferred direction and display the additional object for changing the main object display area. The additional object may be an object for moving the main object display area from the current display surface of the main object to other surface. The additional object may be displayed in other surface than the display surface of the main object. The additional object display surface may be determined based on the main object display area and/or the main object display surface, by way of example. However, the additional object display surface may be changed based on a design and/or user's setting. For example, as shown in FIG. 16A, if the electronic device 101 or 201 is folded in the two-hand grip mode, the processor 220 may display a main object 1611 in the second area of the second surface based on the user preferred direction and display an additional object 1603 for changing the display area of the main object 1611. For example, as shown in FIG. 16B, if the electronic device 101 or 201 is folded in the two-hand grip mode, the processor 220 may display a main object 1613 in the second area of the first surface based on the user preferred direction and display an additional object 1603 for changing the display area of the main object 1613.

According to various embodiments, the electronic device (e.g., the processor 220 may detect selection on the additional object in operation 1503. According to an embodiment, the processor 220 may detect a user touch input for selecting the additional object.

According to various embodiments, the electronic device (e.g., the processor 220) may change the display area of the main object in operation 1505. According to an embodiment, in response to the additional object selection, the processor 220 may move and display the main object from the current display surface to other surface area. According to an embodiment, the processor 220 may change the display area of the additional object based on the changed main object display area. For example, as shown in FIG. 16A, if the main object 1611 is displayed in the second surface and a user input to the additional object 1601 is detected while the additional object 1601 is displayed in the first surface, the processor 220 may control a display (e.g., the display 130 or the display device 260) to display the main object 1613 in the first surface and to display the additional object 1603 in the second surface.

According to various embodiments, an operating method of an electronic device may include detecting a folding angle of the electronic device using at least one sensor circuit, if the determined angle corresponds to a designated first range, displaying a first user interface corresponding to a running application, and if the determined angle corresponds to a designated second range, displaying a second user interface corresponding to the running application, wherein the second user interface may include the same object as the first user interface, and displays at least one object displayed in a first area, in a second area in the first user interface, the first area may include a partial area corresponding to a position of a hinge in a whole area of a flexible display, and the second area may be a different area from the first area.

According to various embodiments, displaying the second user interface may include determining the second area, based on at least one of a contact area detected through the at least one sensor circuit and a hovering input detection area.

According to various embodiments, displaying the second user interface may further include determining a grip mode based on the contact area detected through the at least one sensor circuit, and determining the second area, based on at least one of the grip mode, a grip direction, a hovering input detection direction, or a user preferred direction, wherein the grip mode may include at least one of a one-hand grip mode or a two-hand grip mode.

According to various embodiments, in the one-hand grip mode, the second area may be determined based on at least one of the grip direction or the hovering input detection direction.

According to various embodiments, in the two-hand grip mode, the second area may be determined based on the user preferred direction, and the user preferred direction may include at least one of an object display direction pre-designated by a user or a mainly used direction.

According to various embodiments, the mainly used direction may be determined based on a hovering input detected for a designated time duration or a contact area shape change.

According to various embodiments, the second user interface may be configured to display the at least one object displayed in the first area, in each of the second area and the third area in the first user interface.

According to various embodiments, the second area and the third area may be areas of different directions based on an area corresponding to the position of the hinge in an area of the flexible display.

According to various embodiments, displaying the second user interface may include identifying at least one sub-object in the first user interface, and adjusting a display position of the at least one sub-object in the second user interface, based on a use frequency of the identified sub-object, wherein the sub-object may include an object displayed in other area than the first area in the first user interface.

According to various embodiments, the second user interface may include an additional object for changing a display area of at least on object in the second user interface.

According to various embodiments, an electronic device of a foldable type may change a display position of at least one object based on a mechanical state change, and thus provide improved usability.

While the disclosure has been shown and described with reference to various embodiments thereof, it will be understood by those skilled in the art that various changes in form and details may be made therein without departing from the spirit and scope of the disclosure as defined by the appended claims and their equivalents.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an ASIC.

Various embodiments as set forth herein may be implemented as software (e.g., the program 140) including one or more instructions that are stored in a storage medium (e.g., internal memory 236 or external memory 238) that is readable by a machine (e.g., the electronic device 101, 201). For example, a processor (e.g., the processor 220) of the machine (e.g., the electronic device 101, 201) may invoke at least one of the one or more instructions stored in the storage medium, and execute it the instructions, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., CD-ROM), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a hinge;
a first housing comprising a first surface which faces a first direction and a third surface which faces a second direction facing away the first direction;
a second housing comprising a second surface which faces the first direction and a fourth surface which faces the second direction facing away the first direction, and folding with the first housing based on the hinge;
a flexible display extending from the first surface to the second surface;
at least one sensor circuit for detecting an angle between the first housing and the second housing; and
a processor operatively coupled with the flexible display and the at least one sensor circuit,
wherein the processor is configured to:
when the angle is within a first range, control the flexible display to display a first user interface of a first application, the first user interface comprising a first object that is displayed in a first area, and
when the angle is within a second range, control the flexible display to display a second user interface of the first application, the second user interface comprising the first object that is displayed in a second area,
wherein the first area comprises a partial area that corresponds to a position of the hinge, and
wherein the second area is different from the first area.

2. The electronic device of claim 1, further comprising:
a touch sensor,
wherein the processor is further configured to determine the second area based on at least one of a contact area detected through the touch sensor and a hovering input detection area.

3. The electronic device of claim 2,
wherein the processor is further configured to:
determine a grip mode based on the contact area, and
determine the second area based on at least one of the grip mode, a grip direction, a hovering input detection direction, or a user preferred direction, and
wherein the grip mode comprises at least one of a one-hand grip mode or a two-hand grip mode.

4. The electronic device of claim 3, wherein, in the one-hand grip mode, the processor is configured to determine the second area, based on at least one of the grip direction or the hovering input detection direction.

5. The electronic device of claim 3,
wherein, in the two-hand grip mode, the processor is further configured to determine the second area, based on the user preferred direction, and
wherein the user preferred direction comprises at least one of an object display direction pre-designated by a user or a primary used direction.

6. The electronic device of claim 5, wherein the processor is further configured to determine the primary used direction based on a hovering input detected for a designated time duration or a contact area shape change.

7. The electronic device of claim 1, wherein the second user interface simultaneously includes the first object in the second area and a third area in the first user interface.

8. The electronic device of claim 7, wherein the second area is disposed over the second surface and the third area is disposed over the first surface.

9. The electronic device of claim 1,
wherein the processor is further configured to:
identify at least one sub-object in the first user interface, and
adjust a display position of the at least one sub-object in the second user interface based on a use frequency of the at least one sub-object, and
wherein the at least one sub-object is displayed in a different area than the first area.

10. The electronic device of claim 1, wherein, if the angle is within the second range, the processor is further configured to control the flexible display to display an additional object for changing a display area of at least one second object in the second user interface.

11. A method of operating an electronic device, comprising:
detecting an angle between a first housing of the electronic device and a second housing of the electronic device using at least one sensor circuit;
when the angle is within a first range, displaying a first user interface of a first application, the first user interface comprising a first object displayed in a first area; and
when the angle is within a second range, displaying a second user interface of the running application, the second user interface comprising the first object that is displayed in a second area,
wherein the first area comprises a partial area that corresponds to a position of a hinge, and
wherein the second area is different from the first area.

12. The method of claim 11, wherein the displaying of the second user interface comprises:
determining the second area based on at least one of a contact area detected through the at least one sensor circuit and a hovering input detection area.

13. The method of claim 12,
wherein the displaying of the second user interface further comprises:
determining a grip mode based on the contact area; and
determining the second area, based on at least one of the grip mode, a grip direction, a hovering input detection direction, or a user preferred direction, and
wherein the grip mode comprises at least one of a one-hand grip mode or a two-hand grip mode.

14. The method of claim 13, wherein, in the one-hand grip mode, the second area is determined based on at least one of the grip direction or the hovering input detection direction.

15. The method of claim 13,
wherein, in the two-hand grip mode, the second area is determined based on the user preferred direction, and
wherein the user preferred direction comprises at least one of an object display direction pre-designated by a user or a primary used direction.

16. The method of claim 15, wherein the primary used direction is determined based on a hovering input detected for a designated time duration or a contact area shape change.

17. The method of claim 11, wherein the second user interface simultaneously includes the first object in the second area and a third area in the first user interface.

18. The method of claim 17, wherein the second area is disposed over a second surface associated with the second housing and the third area is disposed over a first surface associated with the first housing.

19. The method of claim 11,
wherein the displaying of the second user interface comprises:
identifying at least one sub-object in the first user interface; and
adjusting a display position of the at least one sub-object in the second user interface, based on a use frequency of the at least one sub-object, and
wherein the at least one sub-object is displayed in a different area than the first area.

20. The method of claim 11, wherein the second user interface comprises an additional object for changing a display area of at least on object in the second user interface.
